(19) United States
(12) Patent Application Publication
(10) Pub. No.: US 2023/0412499 A1
(43) Pub. Date: Dec. 21, 2023

(54) SYSTEMS AND METHODS ON ID SWAPPING DURING DATA FORWARDING

(71) Applicant: HUAWEI TECHNOLOGIES CO., LTD., SHENZHEN (CN)

(72) Inventors: Bidi YING, Kanata (CA); Xu LI, Kanata (CA); Hang ZHANG, Kanata (CA)

(73) Assignee: HUAWEI TECHNOLOGIES CO., LTD., SHENZHEN (CN)

(21) Appl. No.: 18/241,613

(22) Filed: Sep. 1, 2023

Related U.S. Application Data
(63) Continuation of application No. PCT/CN2021/079434, filed on Mar. 6, 2021.

(51) Int. Cl. H04L 45/44; H04L 45/00; H04W 12/02

(52) U.S. Cl. CPC H04L 45/44; H04L 45/70; H04W 12/02

(57) ABSTRACT

Systems and methods on ID swapping during privacy data forwarding. An aspect of the disclosure provides a method for network communication. Such a method includes receiving, by a management function from a policy controller, a first message including a data forwarding policy indicative of a configuration on how to forward data according to a data forwarding requirement from an original data sender. Such a method further includes sending, by the management function to a network function, a second message according to the first message. Such a method further includes obtaining, by the network function, an indication indicating a request for data forwarding and a corresponding flag indicating an ID swapping rule according to the second message.

### CROSS-REFERENCE TO RELATED APPLICATIONS

This is the first application filed for the present invention.

### FIELD OF THE INVENTION

The present invention pertains to the field of communication networks, and in particular to systems and methods on ID swapping during data forwarding.

### BACKGROUND

Mobile telephone subscribers' personal information has become an attractive target for online advertisements and other connected industries. Apart from the danger that this personal information may be utilized for nefarious political agendas, personal information may also be misused for personal advantages. Thus, privacy has turned out to be a primary consideration for end users when selecting and using a telephony service today. From a regulatory compliance perspective, the European Union (EU) General Data Protection Regulation (GDPR) obligations for protecting personal data of subscribers are directly applicable to mobile telephony operators. However, existing technologies may not be adequate to protect personal information from passive or active adversaries in current and future networks.

Therefore, there is a need for a system and methods for ID swapping during privacy data forwarding that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

A method, apparatus and system are provided for enhanced ID privacy during data forwarding. Embodiments may provide for an architecture which may enhance ID privacy. The architecture may provide for facilitating data forwarding policy and dynamically adjusting the data forwarding policy to enhance user equipment (UE) quality of experience (QoE) and improve security. Embodiments may further provide for ID swapping in the UP layer or CP layer during data forwarding without ID privacy leakage.

An aspect of the disclosure provides a method for network communication. Such a method includes receiving, by a management function from a policy controller, a first message including a data forwarding policy indicative of a configuration on how to forward data according to a data forwarding requirement from an original data sender. Such a method further includes sending, by the management function to a network function, a second message according to the first message. Such a method further includes obtaining, by the network function, an indication indicating a request for data forwarding and a corresponding flag indicating an ID swapping rule according to the second message. Accordingly, such an aspect provides a solution which may enable a management function in a communication network to control data forwarding according to a data forwarding requirement from an original data sender.

In some embodiments, the method further includes determining, by the management function, the second message according to the first message, wherein the second message includes the indication and the corresponding flag. In some embodiments, the management function is trusted by the original data sender, the method further comprises: determining, by the management function, an ID swapping rule comprising a policy of forwarding data based on a position ID of a destination of the data packet from the original data sender. In such an embodiment, according to the ID swapping rule: the data packet is forwarded to the destination according to the position ID via the network function and other network functions between the original data sender and the destination, and an ID of the destination of the data packet in the data packet is swapped by the management function with a serving ID of the destination of the data packet which is recognizable by a network including another network function which receives the indication and the corresponding flag. Such embodiments provide a solution which may enable a management function, which is trusted by the original data sender to provide ID privacy protection during data forwarding.

In some embodiments, the position ID is assigned by the management function to the destination of the data packet. In some embodiments, the position ID of the destination is assigned based on an ID of another network function associated with the destination.

In some embodiments, the second message includes a third message from management function to a second network function and a fourth message from the second network function to the network function.

In some embodiments, the method further includes selecting, by the management function, the second network function from a set of second network functions according to the first message; sending the third message to the second network function, wherein the third message includes the data forwarding policy; determining, by the second network function, the indication and the corresponding flag according to the data forwarding policy, and sending, by the second network function to the network function, the indication and the corresponding flag.

Such embodiments provide a solution which may enable a second network function, which is trusted by the original data sender to provide ID privacy by implementing ID swapping during data forwarding without ID privacy leakage.

In some embodiments, the second network function is trusted by the original data sender, and the method further includes determining, by the second network function, an ID swapping rule comprising a policy of forwarding data based on a policy of forwarding data based on partial cryptographic. In such embodiments, according to the ID swapping rule: the destination ID of a data packet or a serving ID corresponding to the destination ID is encrypted by the second network function according to a public key of another network function trusted by the original data sender and associated with a destination of the data packet, and an ID of the destination of the data packet in the data packet is swapped by the management function with a serving ID of the destination of the data packet which is recognizable by a network including the another network function which receives the indication and the corresponding flag.

In some embodiments, the method further includes sending, by the network function to access network (AN) node, a public key associated with the second network function for encrypting a destination ID of a data packet.

In some embodiments, the second network function is trusted by the original data sender, and the method further includes determining, by the second network function, an ID swapping rule comprising a policy of forwarding data based on a policy of forwarding data based on a mix-zone. In such embodiments, according to the ID swapping rule: more than a certain amount of data packets targeting different destinations are to be forwarded by the second network function in a sequence different from what sequence they are received by the second network function, and an ID of the destination of the data packet in the data packet is to be swapped by the management function with a serving ID of the destination of the data packet which is recognizable for the network including the network function

In some embodiments, the method further includes determining, by the second network function, the serving ID according to a mapping between destination IDs and serving IDs. In some embodiments, the method further includes sending, by the network function to the policy controller, a policy request to trigger the policy controller to generate the data forwarding policy, wherein the policy request includes the data forwarding requirement.

In some embodiments, the method further includes obtaining, by the network function from the AN node associated with the original data sender, the data forwarding requirement. In some embodiments, the data forwarding requirement is included in a data packet from the original data sender.

In some embodiments, the method further includes generating, by the policy controller, the data forwarding policy after receiving the policy request; and sending, by the policy controller to the management function, the second message including the data forwarding policy.

Such embodiments provide a solution which may enable a policy controller to determine a data forwarding policy according the data forwarding requirement.

In some embodiments, the data forwarding policy indicative of a configuration on how to forward data further depends on network traffic information, wherein the network traffic information includes at least one traffic parameter associated with one or more of the network function and another network function associated with the network function.

Such embodiments provide a solution which may enable a policy controller to determine a data forwarding policy according to both the data forwarding requirement and additional network traffic information.

In some embodiments, the method further includes sending, by the policy controller to a data analytic management (DAM) function, a network traffic request requesting the network traffic information, wherein the network traffic request includes information on the network function and receiving, by the policy controller from the DAM function, a network traffic response including the network traffic information; wherein the data forwarding policy is based on the data forwarding requirement from the original data sender and the network traffic information. In some embodiments, the original data sender comprises one or more of: a user equipment, and a network function that forwards a data packet.

Such embodiments provide a solution which enables a policy controller to determine a data forwarding policy according to both the data forwarding requirement and additional network traffic information, in which the additional network traffic information is provided by a different network function. Accordingly such a solution may allow for a collection of different information for the policy controller's determination from different network functions.

Another aspect of the disclosure provides a method for execution by a policy controller of a communication network. Such a method includes receiving a policy request to trigger the policy controller to generate a data forwarding policy, the policy request including a data forwarding requirement from an original data sender. Such a method further includes generating the data forwarding policy after receiving the policy request; and sending a first message to a management function, the first message including the data forwarding policy indicative of a configuration on how to forward data according to the data forwarding requirement. Such embodiments provide a solution which enables a policy controller to collect information and accordingly determine a data forwarding policy so as to support ID privacy during data forwarding without ID privacy leakage.

Another aspect of the disclosure provides a method for execution by a network function of a communication network. Such a method includes receiving a message including a data forwarding policy, the data forwarding policy indicative of a configuration on how to forward data according to a data forwarding requirement from an original data sender. Such a method further includes determining, an indication indicating a request for data forwarding and a corresponding flag indicating an ID swapping rule according to the data forwarding policy; and sending, by the network function to another network function, the indication and the corresponding flag. In such a method, the network function is trusted by the original data sender. Such embodiments provide a solution which enables a network function trusted by the original data sender to control data forwarding based on a received data forwarding policy so as to provide ID privacy during data forwarding without ID privacy leakage.

Other aspects of the disclosure provide for systems and apparatus (e.g., network elements) configured for implementing the network functions and for executing the methods described herein.

Other aspects of the disclosure provide for machine readable mediums comprising non-transient memory storing machine readable instructions which when executed by a processor implement the network function configured for executing the methods described herein.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 illustrates an architecture of a future network according to an embodiment of the present disclosure.

FIG. 2 illustrates a data forwarding policy configuration according to an embodiment of the present disclosure.

FIG. 3 illustrates data forwarding based on mix-zone during data forwarding according to an embodiment of the present disclosure.

FIG. 4 illustrates data forwarding based on partial cryptographic during data forwarding, according to an embodiment of the present disclosure.

FIG. 5 illustrates data forwarding based on position ID, according to an embodiment of the present disclosure.

FIG. 6 illustrates available services for different data forwarding policies, according to an embodiment of the present disclosure.

FIG. 7 illustrates a call flow procedure for a data forwarding policy configuration, according to an embodiment of the present disclosure.

FIG. 8 illustrates a call flow procedure for data forwarding based on mix-zone during data forwarding, according to an embodiment of the present disclosure.

FIG. 9 illustrates a call flow procedure for data forwarding based on partial cryptographic during data forwarding, according to an embodiment of the present disclosure.

FIG. 10 is a schematic diagram of a user equipment that may perform any or all of operations of the above methods and features explicitly or implicitly described herein, according to different embodiments of the present invention.

It will be noted that throughout the appended drawings, like features are identified by like reference numerals.

### DETAILED DESCRIPTION

5G security and ID privacy documentation often refers to previous generations for elaboration of various security and privacy requirements, which mainly include User Identity Privacy and User Untraceability. User Identity Privacy may refer to the permanent identity of a user to whom a service is delivered, which cannot be eavesdropped on the radio access link. User Untraceability may refer to tracing a user via different services delivered to the user, such that an intruder cannot deduce whether different services are delivered to the same user by eavesdropping on the radio access link.

It should be noted that the use of the phrase “cannot be eavesdropped” is not limited to and should not be interpreted to refers only to a passive adversary ‘eavesdropping’ on the radio interface but may also include active adversaries. Active adversaries collect, analyze, investigate potential security threats and attack in a variety of forms e.g., DoS attack, internal malicious attack, or collision attack. Accordingly, addressing active adversaries should be considered in future networks.

To address the one or more limitations of the prior art, a temporary ID is introduced and may replace real ID in future networks. Such a temporary ID may be used for communications among different players. Temporary ID may also be used to address traceability threats or attacks, in which the temporary ID may be configured to be unlinkable to the real ID.

Embodiments will now describe data forwarding in user plane (UP) layer.

Network slicing (or a service customized virtual network (VN)) is attracting more attention in the telecommunication industry. In short, a slice is a set of network resources which fits the service attributes and requirements of customer services. The network resources include cloud resources and communication link resources. A slice can serve one or more customer services which share the similar service attributes and requirements. Customer services may include one or more of vertical services (e.g., industry control), over-the-top (OTT) customer services, operator defined services for a group of subscribers, etc.

Given a following example of a pre-defined slice, any endpoints (devices and servers) of the slice should be able to directly use the pre-defined slice to transmit data traffic without per-device or per session triggered end-to-end connection establishment. In the pre-defined slice, a routing protocol may specify how routers communicate with each other to distribute information based on selected and pre-established routes between any two nodes. Pre-established routes means that the routes are establishing before data forwarding. Accordingly, data packets are forwarded through the network from node to node until they reach their destination terminal. Current routing techniques (e.g., distance vector routing protocol, link-state routing protocol, path-vector routing protocol) are based on knowing the destination of the data packet to be routed, in which the routing path is established according to the destination.

To meet the security requirements in future networks, destination terminal identity is changed frequently to protect and enhance ID privacy. However, introduction of temporary IDs poses new issues related to data forwarding.

Since temporary ID may be used to protect ID privacy, an issue may be determining how to map temporary IDs during data forwarding process.

For example, a data packet's destination identifier may be DESTI-ID and the severing identifier for the destination may be ID2. The serving identifier, ID2, may be known to routing nodes in the network but not the destination, DESTI-ID. So, the issue posed here is how would the routing nodes know that the current DESTI-ID corresponds to serving ID2.

Another issue may be determining who is responsible for temporary ID swapping in future networks. A similar issue, due to untrusted network functions or players, may be determining who should have a mapping table indicating relationship between the serving identifiers (e.g., ID2) and the destination identifiers (e.g., DESTI-ID). A further issue may be determining, after temporary ID swapping, how to cloak the serving identifier with other destinations' identifiers. Cloaking may prevent attackers from matching or linking the destination identifier with the corresponding serving identifier.

Embodiments may provide for methods and systems for data forwarding policy configuration and ID swapping during data forwarding process. Embodiments may provide for enhanced ID privacy. Embodiments may further provide for an architecture for facilitating data forwarding policy and dynamically adjusting the data forwarding policy to enhance user equipment (UE) quality of experience (QoE) and improve security. Embodiments may further provide for ID swapping in the UP layer or control plane (CP) layer during data forwarding without ID privacy leakage.

Embodiments may provide for an architecture which may enhance ID privacy. The architecture may configure data forwarding policy dynamically and swap IDs in the UP layer or CP layer during data forwarding process. Embodiments may further provide for a method of managing data forwarding policy. The method may include adjusting data forwarding policy or parameters for a specific data forwarding policy during data forwarding. Embodiments may further provide for methods and systems for swapping temporary IDs during data forwarding without ID privacy leakage. Embodiments will now describe procedures about data forwarding policy configuration and solutions about data forwarding.

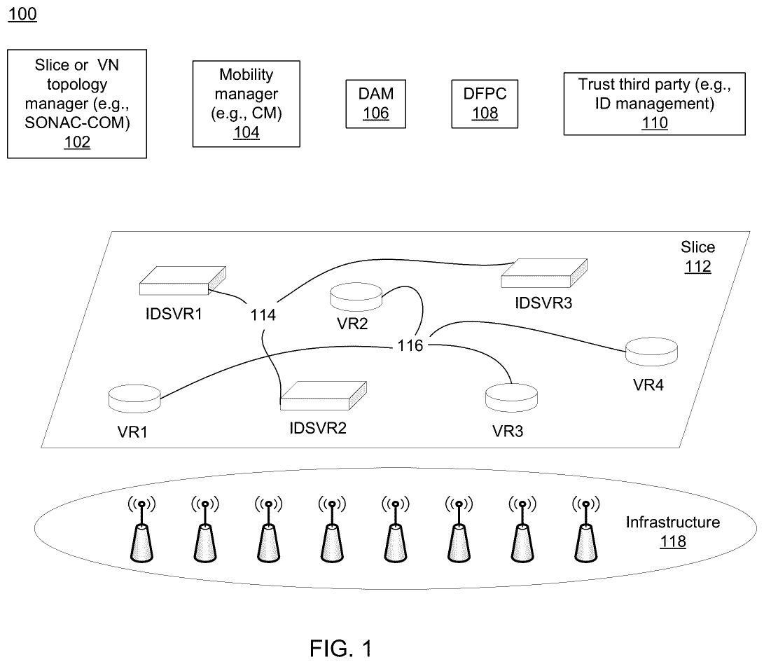

FIG. 1 illustrates an architecture of a future network according to an embodiment of the present disclosure. The architecture 100 may include one or more of: a slice or VN topology manager (e.g., SONAC-COM) 102, a mobility manager 104, a data analytic management (DAM) 106, a data forwarding policy controller (DFPC) 108 or policy controller, and a trust third party (e.g., ID management) 110. The architecture 100 may further include one or more of virtual routing (VR) nodes 116 and ID Swap VR (IDSVR) nodes 114. The architecture may further include infrastructure 118.

The trust third party 110 may be fully trust and responsible for ID management. So, ID management may be controlled by the trust third party 110. The trust third party 110 may be deployed decentralized. The DFPC 108, VR nodes 116, slice or VN topology manager 102, and DAM 106 may be semi-honest setting deployed by networks. The mobility manager 104 may be trust. The trust third party or ID management 110 may have its own public key, private key or both. Each IDSVR 114 may have its own public key, private key or both. The IDSVRs' public key may be published to mobility manager 104 and VR nodes 116. The VRs' public key may be published to IDSVR nodes 114. IDSVR nodes 114 and VR nodes 116 may be connected in a mesh structure as may be appreciated by a person skilled in the art.

Slice or VN topology manager 102 may be responsible for the end-to-end slice composition, which includes at least customer service User plane (UP) slices, for example slice 112. The end-to-end slices including UP slices may be determined by slice providers and deployed over the entitled infrastructure network. It should be noted that a UP slice comprises a set of resources for delivering data traffic to and from endpoints of the slice. Further, it should be noted that an integrated infrastructure network may comprise multiple technical domains, e.g., radio access network (RAN) domains, transport domains, etc., which use different techniques for data traffic forwarding.

Mobility manager 104 may be responsible for providing the reach-ability information of devices for traffic delivery over slices. Mobility manage may, particularly, decouple the name of a device from its location. Location information of a device may be associated with the name of the device, and its current “location” may be one or more of: the ID of an access node, the ID of a RAN cluster or the ID of a virtual anchor point function.

In some embodiments, the mobility manager 104 may be referred to as a management function, which may perform one or more functions of the mobility manager 104 as described herein.

DAM 106 may be responsible for providing on-demand network data log and analytics. DFPC 108 may be responsible for data forwarding policy configuration. ID management entity may be responsible for managing temporary IDs. As discussed herein, ID management may be controlled by trust third party 110.

VR nodes 116 may be responsible for inter-connections among nodes in the selected slice and for data forwarding in the UP layer. A VR tunnel may be defined as the logical connection between two VR nodes of the selected slice. In a RAN domain, one open VR tunnel may be defined as the logical connection between a VR node and an access node.

IDSVR nodes 114 may be responsible for ID swapping in addition to the responsibilities of VR nodes. Infrastructure 118 may be responsible for user access and providing physical resources.

As may be appreciated by a person skilled in the art, in some embodiments, VR nodes 116 may be referred to as network functions 116, which may be configured to perform one or more functions of the VR nodes 116 as described herein. Similarly, the IDSVR 114 may also be referred to as network functions, which may be configured to perform one or more functions of the IDSVR 114.

Architecture 100 may include one or more interfaces. Architecture 100 may include an interface between trust third party (or ID management) 110 and mobility manager 104. Architecture 100 may further include an interface between mobility manager 104 and slice or VN topology manager 102. Architecture 100 may further include an interface between slice or VN topology manager 102 and VR nodes 116. Architecture 100 may further include an interface between slice or VN topology manager 102 and IDSVR nodes 114. Architecture 100 may further include an interface between mobility manager 104 and VR nodes 116. Architecture 100 may further include an interface between mobility manager 104 and IDSVR nodes 114. Architecture 100 may further include an interface between slice or VN topology manager 102 and the physical infrastructure 118. Architecture 100 may further include an interface between VR nodes 116 or IDSVR nodes 114 and DFPC 108. Architecture 100 may further include an interface between DFPC 108 and DAM 106. Architecture 100 may further include an interface between DFPC 108 and mobility manager 104.

Referring to architecture 100, given a selected UP slice, for example slice 112, may be a pre-defined slice, as discussed above, and accordingly all involved VR nodes 116 or IDSVR nodes 114 may ‘know’ how to handle data packets of this slice. As such, VR nodes 116 and IDSVR nodes 114 may have pre-setup routing paths within the slice 112. The operation of such a slice may be simplified. For example, per device end-to-end session establishment may not be needed since the slice may be a pre-defined slice. So, slice 112 may be used for data delivery in a pre-defined slice and data delivery for PDU session establishment. Only the connection between a device and one or more access nodes may be needed, which may result in reduced signaling. Accordingly, data transmission from a mobile to the network may be performed by ‘selecting’ a right ‘entry point’ of a slice. This selection may occur, for example, during the movement of the mobile device. Similarly, the downlink (DL) data delivery to the mobile device from the network or uplink (UL) data delivery to the network may be performed by ‘selecting’ a right ‘exit point’ of a slice. This simplified operation of a slice may reduce the associated complexity (e.g., overhead signaling and latency).

In a selected UP slice, for example slice 112, a routing protocol may specify how routers communicate with each other to distribute information based on selected and pre-established routes between any two nodes. Pre-established routes means that the routes are establishing before data forwarding. Accordingly, data packets are forwarded through the network from node to node until they reach their destination terminal. To meet the security requirements in future networks, destination terminal identity is changed frequently to protect and enhance ID privacy. However, introduction of temporary IDs poses new issues related to data forwarding as discussed above, including temporary ID swapping.

It should be noted that temporary ID swapping may be required for per device end-to-end session establishment, whether UP slice is present or not. Accordingly, embodiments relating to temporary ID swapping may apply to the case of UP slice or otherwise.

Architecture 100 may enable a more secure data forwarding protocol partly due to unlinkable temporary IDs per UE. Accordingly, architecture 100 may provide security against temporary ID tractability attacks. Besides, mobility manager 104 may decouple VR node identity from location thereby providing protection for UE location privacy.

Referring to FIG. 1, the slice or VN topology manager 102 may perform several functions. The slice or VN topology manager 102 may obtain infrastructure topology information from infrastructure providers 118. The slice or VN topology manager 102 may create one or more of slices or VNs. The slice or VN topology manager 102 may configure inter-connections or interfaces of VR nodes in the one or more slices or VNs. The slice or VN topology manager 102 may configure one or more routing tables based on identifier(s) of one or more VR nodes and IDSVR nodes. The slice or VN topology manager 102 may configure infrastructure equipment for mapping one or more slice logical tunnels to physical infrastructure network. The slice or VN topology manager 102 may configure one or more VR nodes and IDSVR nodes for controlling and managing access link resources to enable an end-to-end slice.

The mobility manager 104 may perform several functions. The mobility manager 104 may maintain a mapping, for example, a table of relation, between mobile terminal temporary ID and one or more of: current serving VR identifier and IDSVR identifier (e.g., a VR node may cover one or more cells or one or more cluster nodes, etc.).

The mobility manager 104 may be responsible for location tracking or query. The mobility manager 104 may update the location table of relation whenever a mobile terminal performs a location update or VR nodes monitor such a change. The mobility manager 104 may return the current serving VR ID or IDSVR ID in response to receiving a location query request.

The mobility manager 104 may be responsible for activity configuration and tracking. The mobility manager 104 may configure and track the activity status of a device, e.g., a scheduler at an access node for scheduling the DL traffic delivery, which may include scheduling when to deliver packets to the device.

The mobility manager 104 may be responsible for possible temporary ID binding relation and mapping. The mobility manager 104 may maintain one or more encrypted mapping tables with temporary IDs.

The mobility manager 104 may have a function of proxy for re-encryption. The mobility manager 104 may run a data forwarding policy based on position ID. The ID management may keep a mapping table with all serving temporary IDs.

The VR nodes 116 may perform several functions. The VR nodes 116 may determine the next hop VR node based on one or more of a slice or a VN routing table. The VR nodes 116 may configure a tunnel, e.g., an egress VR ID. The VR node 116 may configure one or more routing table, e.g., destination VR ID, next VR ID. The VR nodes 116 may provide physical address of next hop VR node to an underline physical entity. The VR nodes 116 may forward one or more packets to the current VR node of the destination mobile terminal. The VR nodes 116 may associate with the mobility manager 104 to query for UE's location.

The IDSVR nodes 114 may perform several functions. The IDSVR nodes 114 may perform similar functions as those performed by VR nodes 116. In addition, the IDSVR nodes 114 may receive notification for Temporary ID swap. The IDSVR nodes 114 may further perform temporary ID swapping. The IDSVR nodes 114 may further perform one or more of encryption or decryption. The IDSVR nodes 114 may further run mix-zone method based k-anonymity.

The DAM 106 may provide data log and analytics service. For example, the DAM 106 may provide network traffic information for network performance optimization.

The DFPC 108 may maintain different confirmation descriptions about data forwarding policy. The DFPC 108 may further decide on data forwarding policy selection.

Embodiments may provide for data forwarding based on position ID. In such embodiments, the mobility manager 104 may perform several functions. The mobility manager 104 may be responsible for location tracking and act as a resolution manager. The mobility manager 104 may receive notification from ID management about a change, for example, the DESTI-ID is changed to DESTI-ID1. The mobility manager 104 may update position table and maintain the relation between DESTI-ID and DESTI-ID1. The mobility manager 104 may perform location tracking.

The mobility manager 104 may perform location resolution. For example, the mobility manager 104 may receive a location resolution request including a destination mobile ID (e.g., DESTI-ID). The mobility manager 104 may, based on the destination mobile ID (e.g., DESTI-ID), search for corresponding position ID (current serving virtual node ID (data plane)+R-ID). For example, if a virtual node ID is “001” and the R-ID is “11”, then the position ID may be “00111”. The mobility manager 104 may then return the current position ID (serving virtual node ID +R-ID) of the destination. Note that R-ID (e.g., a unique ID of an endpoint within a virtual node) is generated by mobility manager and assigned to a specific UE. The position ID is mapped to the identity of a specific UE by the mobility manager.

The allocation of responsibilities and functions to the entities involved in the architecture 100 as discussed herein may enable a secure data forwarding protocol based on temporary IDs.

Embodiments will now describe data forwarding policy configuration.

In a selected UP slice, VR nodes 116 may be fixed and have their neighbor nodes information such as location and identity. A data routing path may be established using existing routing protocols (e.g., flooding protocol) according to the destination of one or more data packets. For example, a data packet having arrived at a VR node, may include the source identity, the destination identity or both. If this VR node can recognize the destination identity and has knowledge of the location of the destination identity, the VR node may search the next hop node. If the VR node does not know the destination identity, it may forward the data packet to a network function, for example, DFPC 108, which may be responsible for configuring data forwarding policy. After configuration, the data packet may be delivered to the final VR node where the destination is located.

The network function DFPC 108 may have three configuration options for data forwarding policy, namely, data forwarding based on mix-zone, data forwarding based on partial cryptographic, and data forwarding based on position ID. Details of each data forwarding policy is discussed elsewhere herein. A person skilled in the art may appreciate that a VR node 116 or IDSVR node 114 may keep a Flag which represents a status of data forwarding policy. The value of the flag may indicate the configuration option of the data forwarding policy, for example, a Flag value of “010” may mean or indicate data forwarding based on mix-zone, a Flag value of “011” may mean or indicate data forwarding based on partial cryptographic, a Flag value of “000” may mean or indicate data forwarding based on position ID, and other Flag values may mean that no data forwarding policy is configured in the network.

A person skilled in the art may appreciate that embodiments described herein, including embodiments related to data forwarding, may be applicable and used for data forwarding based on PDU session (current 5G PDU session data delivery).

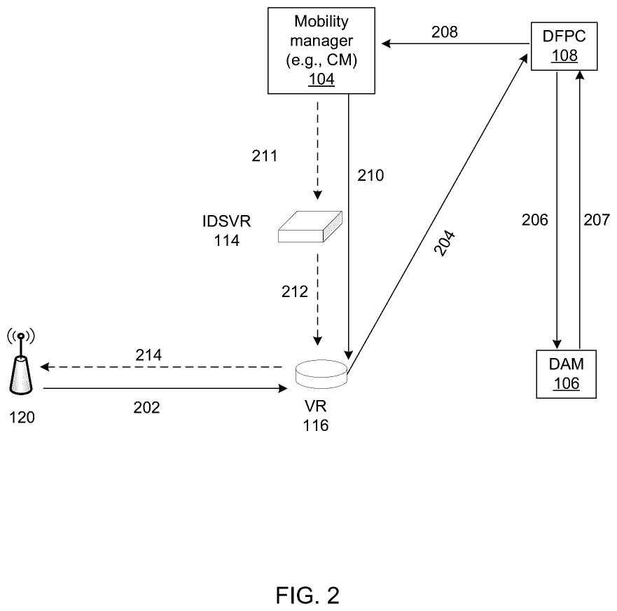

FIG. 2 illustrates a data forwarding policy configuration according to an embodiment of the present disclosure.

At 202, a data packet may arrive from an access node 120 to VR node 116. This data packet may include one or more parameters, e.g., flow ID, source address (e.g., source-ID), destination address (destination ID (e.g., DESTI-account)), data forwarding policy requirements. In some embodiments, the AN 120 may be associated with the original data sender, and the VR 116 may obtain, e.g., at 202, from the access node 120 associated with the original data sender, the data forwarding requirements. The original data sender may comprise one or more of a user equipment and a network function (e.g., VR or IDSVR) that forwards a data packet as described herein.

At 204, if the VR node 116 does not know the destination address (e.g., DESTI-ID) and the value of the Flag does not indicate that any data forwarding policy is configured in the network, the VR node 116 may send a data forwarding policy request to DFPC (which is an example of a policy controller) 108. The data forwarding policy request may include one or more parameters, e.g., flow ID and data forwarding policy requirements. In some embodiment, the data forwarding policy request may be delivered to DFPC 108 via IDSVR node 114, or mobility manager 104, or DAM 106, or both IDSVR node 114 and mobility manager 104.

In some embodiments, the VR 116, may send, e.g., at 204, to the DFPC 108, a policy request to trigger the DFPC 108 to generate the data forwarding policy, wherein the policy request includes the data forwarding requirement.

At 206, after receiving the data forwarding policy request, DFPC 108 may send a network traffic request to DAM 106. The network traffic request may include one or more parameters, e.g., network traffic information (e.g., traffic load in the network, information about traffic load in VR nodes 116 or IDSVR nodes 114). Then, DAM 106 may send, at 207, a network traffic response back to DFPC 108. This response may include one or more parameters, e.g., network traffic load in VR nodes 116 or IDSVR nodes 114.

After receiving the network traffic response, DFPC 108 may decide on the data forwarding policy according to the network traffic information and the data forwarding policy requirements. Then, DFPC 108 may, at 208, send a data forwarding policy configuration message to mobility manager (e.g., CM) 104. In some embodiments, the DFPC 108 may generate, the data forwarding policy after receiving the policy request (received e.g., at 204).

The data forwarding policy configuration message may include one or more parameters, e.g., flow ID, configuration description about the required data forwarding policy (e.g., an index which indicates which data forwarding policy is activated), and parameters about data forwarding policy (e.g., value of K used in the data forwarding based on mix-zone, or, one or more of encryption and decryption algorithms, or an indication of criteria or factors of IDSVR node selection).

In some embodiments, the mobility manager 104 may receive, at 208 for example, from the DFPC 108, a message (a first message) including a data forwarding policy indicative of a configuration on how to forward data according to a data forwarding requirement from an original data sender. As mentioned, the data forwarding requirement may be indicated in the data packet received by the access node 120 from the original data sender.

In some embodiments, the data forwarding policy indicative of a configuration on how to forward data depends on both the data forwarding requirement and on network traffic information. The network traffic information includes at least one traffic parameter associated with a network including one or more of the VR 116 or other network function associated with the network function 116. Accordingly, in some embodiments, the DFPC 108 may send, e.g., at 206, to the DAM function 106, a network traffic request requesting for the network traffic information, wherein the network traffic request includes information on the VR 116. The DFPC 108 may then receive, e.g., at 207, from the DAM function 106, a network traffic response including the network traffic information. Accordingly, the data forwarding policy may be based on both the data forwarding requirement from the original data sender and the network traffic information.

In some embodiments, the mobility manager 104 (which is an example of a management function) may send, e.g., at 210, or 212 via 211, to the VR 116 a message (second message) according to the first message (e.g., message including the data forwarding policy) received (at 208) from the policy control. The VR 116 may then obtain, e.g., at 210 or 212, an indication indicating a request for data forwarding and a corresponding flag indicating an ID swapping rule according to the message received from the mobility manager.

In some embodiments, mobility manager 104, may determine, e.g., at 210, according to the second message received at 208, the indication and the corresponding flag that is sent to VR 116. As may be appreciated by a person skilled in the art, the mobility manager 104 may be trusted by the original data sender.

In some embodiments, after receiving the data forwarding policy configuration message, mobility manager (e.g., CM) 104 may run the configuration description if the required data forwarding policy is a data forwarding based on position ID. Then, mobility manager (e.g., CM) 104 may send an ID-Swapping-Flag message to the VR node 116. The ID-Swapping-Flag message may indicate that data forwarding policy is based on position ID. In some embodiments, mobility manager (e.g., CM) 104 may select IDSVR node 114 based on the indication of criteria or factors of IDSVR node selection, and then, send at 211 the data forwarding policy configuration message to IDSVR node 114.

In some embodiments, IDSVR node 114 may set the value of Flag and configure parameters about data forwarding policy according to the data forwarding policy configuration. Then, IDSVR node 114 may, at 212, send the ID-Swapping-Flag message which may indicate data forwarding based on mix-zone or data forwarding based on partial cryptographic, to the VR node 116. The ID-Swapping-Flag message may include one or more parameters, e.g., flow ID and value of the Flag.

In some embodiments, if the value of Flag indicates that data forwarding is based on partial cryptographic, the VR node 116 may at 214, send the ID-Swapping-Flag message together with IDSVR node's public key to the access node 120.

In some embodiments, the mobility manager 104 may determine an ID swapping rule comprising a policy of forwarding data based on a position ID of a destination of the data packet from the original data sender.

According to the ID swapping rule, the data packet is forwarded to the destination according to the position ID via a VR 116 (a network function) and other VRs 116 (network functions) between the original data sender and the destination. Further, according to the ID swapping rule, an ID of the destination of the data packet in the data packet is swapped by the mobility manager 104 with a serving ID of the destination of the data packet which is recognizable for the network including the VR 116.

In some embodiments, the position ID may be assigned by the mobility manager 104 to the destination of the data packet. As may be appreciated by a person skilled in the art, the position ID of the destination may be assigned based on an ID of another VR associated with the destination, which may not be the VR 116 in FIG. 2 but a VR that is close to, or associated with, the destination.

In some embodiments, the second message (received from the mobility manager 104 by the VR 116) may include a third message (from the mobility manager 104 to the IDSVR 114). In some embodiments, the second message may include a fourth message (from the IDSVR 114 to the VR 116).

In some embodiments, the mobility manager 104, may select the IDSVR 114 from a set of IDSVRs according to the first message. The mobility manger may then send, e.g., at 211, the third message including the data forwarding policy to the IDSVR 114. The IDSVR 114 may then send, e.g., at 212m to the VR 116, the indication and corresponding flag.

In some embodiments, the IDSVR 114 may be trusted by the original data sender. In some embodiments, the IDSVR 114 may determine an ID swapping rule comprising a policy of forwarding data based on a policy of forwarding data based on partial cryptographic. According to the ID swapping rule, the destination ID of a data packet or a serving ID corresponding to the destination ID may be encrypted by the IDSVR 114 according to a public key of another network function (e.g., IDSVR) trusted by the original data sender and associated with a destination of the data packet. As may be appreciated by a person skilled in the art, in some embodiments, only the destination ID (or the serving ID corresponding to the destination ID) may be encrypted according to the ID swapping rule and no other information indicated by the ID swapping rule. In addition, according to the ID swapping rule, an ID of the destination of the data packet in the data packet may be swapped by the mobility manager 104 with a serving ID of the destination of the data packet which may be recognizable for the network including the VR 116.

In some embodiments, the VR 116 may send, e.g., at 214, to the AN node 120, a public key associated with the IDSVR 114 for encrypting a destination ID of a data packet as described herein.

In some embodiments, the IDSVR 114 may be trusted by the original data sender. In some embodiments, the IDSVR 114 may determine an ID swapping rule comprising a policy of forwarding data based on a policy of forwarding data based on mix-zone. According to the ID swapping rule, more than a certain amount data packets targeting different destinations may be forwarded by the IDSVR 114 in a sequence different from what sequence they (the certain amount data packets) are received by the IDSVR 114. Further, according to the ID swapping rule an ID of the destination of the data packet in the data packet may be swapped by the mobility manager 104 with a serving ID of the destination of the data packet which is recognizable for the network including the VR 116.

In some embodiments, the IDSVR 114 may determine the serving ID (of the destination of the data packet) according to a mapping between destination IDs and serving IDs.

In some embodiments, DFPC 108 may, dynamically, adjust the data forwarding policy according to network traffic load. In this case, DFPC 108 may send the new configuration description or parameters about data forwarding policy to the mobility manager (e.g., CM) 104 or IDSVR node 114 to re-configure parameters about data forwarding policy. A person skill in the art may appreciate that DFPC 108 may change a data forwarding policy to another data forwarding policy or may change some parameters for the same data forwarding policy.

The procedure and steps illustrated in FIG. 2 may enable changing the data forwarding policy dynamically during data forwarding according to network traffic load and security requirements. Changing the data forwarding policy dynamically, for example, during data forwarding, may enhance UE QoE and improve ID privacy requirements.

Embodiments will now describe temporary ID swapping during data forwarding.

For illustrative purposes and without limiting the scope of the invention some definitions about IDs for a specific UE in data forwarding process may be provided. DESTI-ID may refer to an identifier of the destination, which may be indicated in a data packet arriving from an access node. A Serving identifier of the destination may be e.g., S-ID, which may be known to the network. The final VR node or final IDSVR node may be where the destination is located. The source identifier may be referred to as Source-ID.

Embodiments will now describe data forwarding based on mix-zone.

The concept of data forwarding based on mix-zone may be based on at least k different temporary IDs which may be required for ID swapping during a given period time. The concept of data forwarding based on mix-zone may be further based on one or more ingress packets and egress packets, which may not be linked from temporary IDs. The concept of data forwarding based on mix-zone may further be based on sequences of ingress packets and egress packets that are mixed.

The functions of IDSVR node 114, in data forwarding based on mix-zone, may include waiting for at least k ingress packets with different destinations. The functions of IDSVR node 114 may further include querying for locations if IDSVR node 114 does not have the required locations. For example, the IDSVR node 114 may request location from mobility manage (e.g., CM) 104. The functions of IDSVR node 114 may further include sending egress packets with swapped temporary ID to the next hop forwarder.

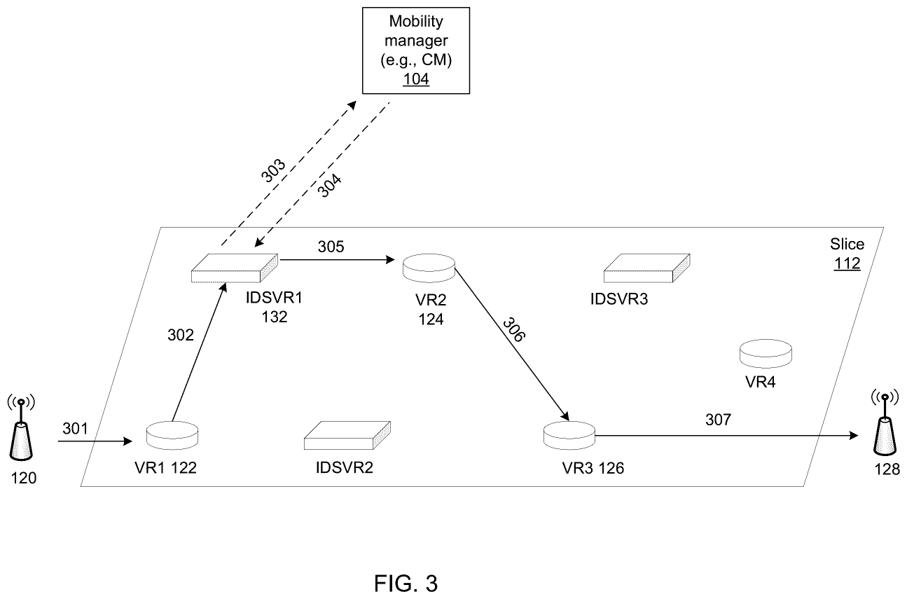

FIG. 3 illustrates data forwarding based on mix-zone during data forwarding according to an embodiment of the present disclosure.

Referring to FIG. 3, a data packet from RAN node 120, may arrive at a VR node 116 (e.g., VR1 122). The data packet may include one or more parameters, e.g., flow ID, data forwarding policy requirements, source identifier (e.g., Source-ID), destination identifier (e.g., DESTI-ID), and content of data. VR1 node 122 may check whether the destination identifier is in the network. If the destination identifier is in the network, VR1 node 122 may search the destination's location if the VR1 node 122 does not know the destination's location. In some embodiments, VR1 node 122 may search the destination's location by sending, a request to the mobility manager (e.g., CM) 104 and receiving, a response therefrom. Further details on how the VR1 node 122 may search the location of the destination is described elsewhere herein.

In some embodiments, upon determining the destination's location, then VR1 node 122 may determine the next hop VR node based on the destination's location. Then VR1 node 122 may forward the data packet to the destination VR (e.g., VR3 126). Then, the destination VR (e.g., VR3 126) may forward the data packet to the destination RAN node (e.g., RAN node 128).

In some embodiments, if the data packet satisfies a set of conditions, VR1 node 122 may, at 302, forward the data packet to an IDSVR node 114 (e.g., IDSVR1 node 132). The set of conditions may include that the destination identity is not on the network. The set of conditions may further include that a data forwarding based on mix-zone is required. The set of conditions may further include that the value of Flag indicates that data forwarding based on mix-zone is configured. Provided that these conditions are met, the VR1 node 122 may forward, at 302, the data packet to IDSVR1 node 132. This IDSVR1 node 132 may be selected according to the distance between the IDSVR1 node 132 and VR1 node 122, or traffic load on IDSVR1 node 132, or other selected criteria.

When the data packet arrives at IDSVR1 node 132, it may perform one or more functions. The IDSVR1 node 132 may wait for at least k data packets having different destinations, provided the at least k data packets do not have requirements of real-time or emergency. The IDSVR1 node 132 may further map the destination identity to the destination UE's serving temporary ID. If IDSVR1 node 132 does not have the location of the destination, it may send a location request to the mobility manager 104, for example at 303. The mobility manager 104 may, at 304, send a response back to the IDSVR1 node 132. Further details on how the IDSVR1 node 132 may search the location of the destination is described elsewhere herein. The IDSVR1 node 132 may further determine the next hop VR node based on the location of the destination. In some embodiments the next hop VR node may be a VR node or an IDSVR node.

The IDSVR1 node 132 may forward the k data packets in a difference sequence than the sequence in which the k data packets entered the IDSVR1 node 132. In other words, the sequence in which the k data packets entered the IDSVR1 node 132 may be different than the sequence in which the k data packets exit the IDSVR1 node 132. In forwarding the k data packets in different sequences, the IDSVR1 node 132 may, at 305, also forward the data packet received at 302 (from VR1 node 122), to VR2 node 124.

When the data packet from IDSVR1 node 132 arrives at a VR2 node 124, it may perform one or more functions. The VR2 node 124 may, at 306, forward the data packet to the next hop VR node (e.g., VR3 node 126). The next VR node may repeat step 306 until the data packet arrives at the destination VR node (e.g., VR3 126). Then, the destination VR (e.g., VR3 126) may forward, for example, at 307, the data packet to the destination RAN node (e.g., RAN node 128).

A person skilled in the art may appreciate that existing solutions to determine the next hop node may be used in this procedure. Existing solutions may include distance-vector routing protocol which measures the distance by the number of routers a packet has to pass. To determine the best route across a network, router nodes, on which a distance-vector protocol is implemented, may exchange information with one another. Information exchanged may include routing tables plus hop counts for destination networks and possibly other traffic information. Distance-vector routing protocol may further include the router nodes, periodically, informing their neighbors of network topology changes.

A VR node 116 (e.g., VR1 node 122, VR2 node 124 or VR3 node 126) or an IDSVR node 114 (e.g., ISDVR1 node 132) may search location of a packet destination via the mobility manager 104. The VR node 116 or IDSVR node 114 may send a location request to the mobility manager 104. This location request may include one or more parameters, e.g., temporary ID of the destination. The mobility manager 104 may send a location response back to the VR node 116 or IDSVR node 114. This location response may include one or more parameters, e.g., the ID of the destination location.

Embodiments will now describe data forwarding based on partial cryptographic. The concept of data forwarding based on partial cryptographic may be based on searching and mapping a requested temporary ID with a serving temporary ID. The concept of data forwarding based on partial cryptographic may further be based on encrypting the serving temporary ID.

The functions of IDSVR node 114, in data forwarding based on partial cryptographic, may include swapping temporary IDs. The functions of IDSVR node 114 may further include encrypting and decrypting temporary IDs. The functions of IDSVR node 114 may further include querying for locations for which IDSVR node 114 may not have or know, for example, IDSVR node 114 may not know how to route to the location indicated in a data packet. The functions of IDSVR node 114 may further include sending egress packets with swapped temporary ID to the next hop forwarder. A person skilled in the art may appreciate that in data forwarding based on partial cryptographic, the IDSVR node 114 may not wait for at least k ingress packets as in the case of data forwarding based on mix-zone, which may provide for less delay.

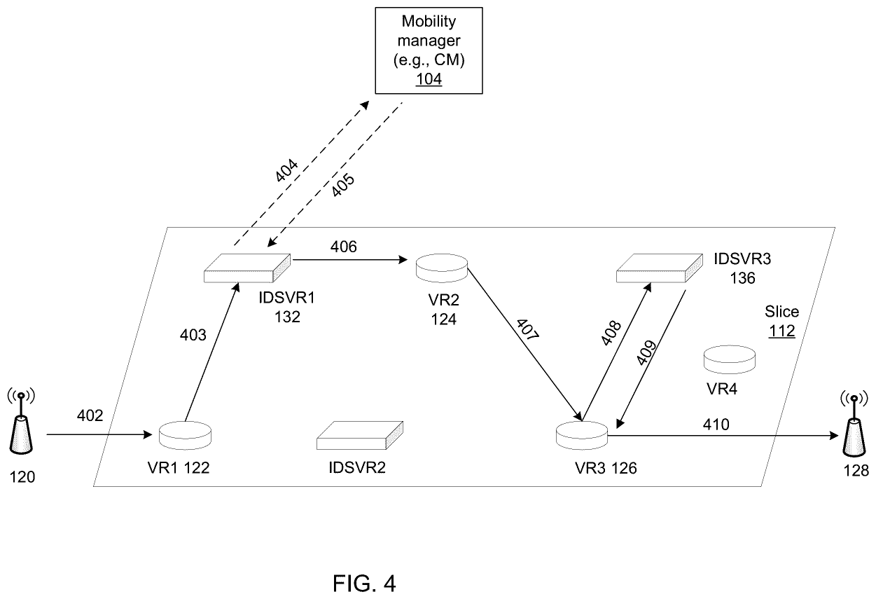

FIG. 4 illustrates data forwarding based on partial cryptographic during data forwarding, according to an embodiment of the present disclosure.

At 402, a data packet may arrive at a VR node 116 (e.g., VR1 node 122) from a radio access network (RAN) node 120. The data packet may include one or more parameters, e.g., flow ID, data forwarding policy requirements, source identifier (e.g., Source-ID), destination identifier (e.g., DESTI-ID), content of data, and IDSVR node identifier (e.g., IDSVR1). The destination identifier DESTI-ID may be encrypted, by the RAN node 120, using an IDSVR node's (e.g., IDSVR1 node 132) public key. The RAN node which may connect to the VR node or the IDSVR node may have IDSVR node's (e.g., IDSVR1 node 132) public key. By encrypting the DESTI-ID, the VR1 node 122 may not know the DESTI-ID. Upon receiving the data packet, the VR1 122 may, at 403, forward the data packet to the IDSVR node (e.g., IDSVR1 node 132) directly.

After receiving the data packet, IDSVR1 node 132 may decrypt and obtain the destination identifier, DESTI-ID. The IDSVR1 node 132 may perform one or more functions based on a first option. The one or more functions based on the first option may include checking, by the IDSVR1 node 132, whether the destination identity DESTI-ID is in the network. If the destination identity DESTI-ID is on the network, the IDSVR1 node 132 may search the destination's location if IDSVR1 node 132 does not know the destination's location. The one or more functions based on the first option may further include searching, by the IDSVR1 node 132, the destination's location by sending a request, at 404, to the mobility manager (e.g., CM) 104 and receive a response, at 405, therefrom. Details on how the ISVR1 node 132 may search for the destination's location is described elsewhere herein. The IDSVR1 node 132 may then determine the next hop VR based on the destination's location.

In some embodiments, upon receiving the data packet, the IDSVR1 node 132 may perform one or more functions based on a second option. The one or more functions based on a second option may include, swapping, by the IDSVR1 node 132, the destination identifier if the data packet satisfies a set of conditions. The set of conditions may include that the destination identity is not on the network. The set of conditions may further include that a data forwarding based on partial cryptographic is required. The set of conditions may further include that the value of Flag indicates that data forwarding based on partial cryptographic is configured. For example, the destination identifier “DESTI-ID” may be mapped to the serving identifier “S-ID2” of the destination.

Where the IDSVR1 node 132 performs functions based on the first option, the IDSVR1 node 312 may forward, at 406, the data packet to the next hop, e.g., VR2 node 124, based on the destination's location, and the data packet may include one or more parameters e.g., flow ID, Source-ID, destination identifier DESTI-ID.

Where the IDSVR1 node 132 performs functions based on the second option, the IDSVR1 node 312 may forward, at 406, the data packet to the next hop, e.g., VR2 node 124, based on the destination's location, and the data packet may include one or more parameters e.g., flow ID, Source-ID, serving identifier “S-ID2” of the destination which is encrypted using an available IDSVR node's (e.g., IDSVR3 node 136) public key, and identifier of the available IDSVR (e.g., IDSVR3 node 136). The available IDSVR node may be determined according to the destination's location, e.g., the IDSVR node closest to the destination's location may be selected.

The VR2 node 124 may, at 407, forward the data packet to the destination VR node, e.g., the serving VR node (e.g., VR3 node 126), the data packet including the respective information according to the first or second option as described above. The VR3 node 126 may, at 408, send the data packet to IDSVR3 136.

In embodiments in which the IDSVR1 node 132 performs functions based on the first option, the serving VR node, VR3 node 126, where the destination node is located, may receive the data packet, and then VR3 node 126 may send the data packet to the destination RAN node (e.g., RAN node 128), for example, at 410.

In embodiments in which the IDSVR1 node 132 performs functions based on the second option, the serving VR node, VR3 node 126, where the destination node is located, may receive the data packet. The VR3 node 126 may send the data packet to the IDSVR node (e.g., IDSVR3 node 136), for example, at 408. Upon receiving the data packet, the IDSVR node (e.g., IDSVR3 node 136) may decrypt and obtain the destination identifier. The IDSVR3 node 136 may send the data packet to the destination node if the destination node is within it's the coverage of the IDSVR3 node 136. If the destination node is within the coverage of the VR3 126, the IDSVR3 node 136 may send, at 409, the decrypted data packet to the destination VR node (e.g., VR3 126). The decrypted data packet may include one or more parameters, e.g., flow ID, Source-ID, serving identifier “S-ID2” of the destination.

Embodiments will now describe data forwarding based on position ID.

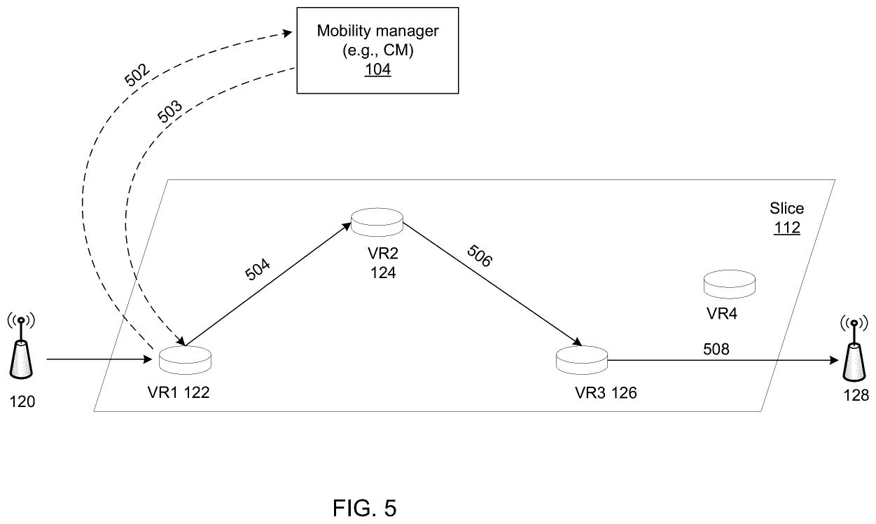

FIG. 5 illustrates data forwarding based on position ID, according to an embodiment of the present disclosure.

The serving node of source VR (e.g., VR1 node 122) may receive a data packet with a destination mobile ID (e.g., DESTI-ID). The VR1 node 122 may search local endpoint routing table based on DESTI-ID. If the search yields no result, then the VR1 node 122 may, at 502, send a request for current position ID to the mobility manager (e.g., CM) 104. The mobility manager 104 may be a trust function and may be configured to maintain and ID mapping table of temporary ID relationships

The VR1 node 122 may, at 503, receive a response from the mobility manager 104, the response including information about (e.g., DESTI-ID) and a position ID. The format of position ID may include: a current serving virtual node (VR) (e.g., cell) and an R-ID (a unique ID of an endpoint within a virtual node).

The VR1 node 122 may then, at 504, route the data packet toward the current serving node based on information within the position ID of the destination endpoint. Accordingly, the VR1 node 122 may send the data packet to virtual service node (e.g., VR2 node 124).

The VR2 node 124 may receive the data packet and forward the data packet toward the virtual serving node of the destination endpoint based on a pre-defined slice level routing table. Accordingly, the VR2 node 124 may forward, at 506, the data packet to virtual serving node (cell) of destination VR node (VR3 node 126).

The VR3 node 126 may receive the data packet and deliver, at 508, the packets to the destination RAN node (e.g., RAN node 128) based on R-ID information within position ID.

Embodiments discussed with respect to data forwarding policy may provide for temporary ID swapping during data forwarding process. The data forwarding procedures described in embodiments herein may provide for ID swapping in the CP layer and ID swapping in the UP layer. Further, these embodiments may enhance protection for ID privacy during data forwarding.

Embodiments will now describe customized data forwarding policy based on multiple options. According to security requirements and QoS requirements for data packets, DFPC 108 may provide different options for data forwarding. Data forwarding policy may further be changed dynamically based on network traffic information.

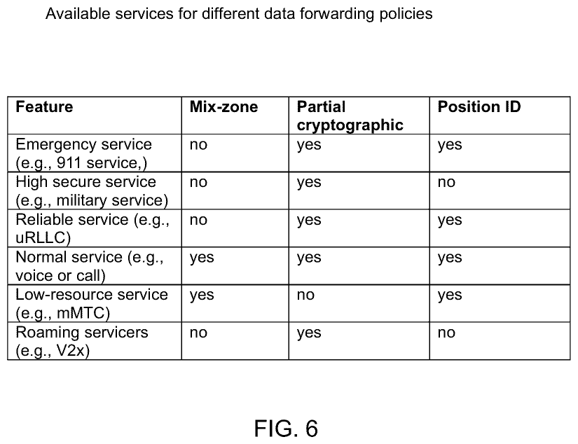

FIG. 6 illustrates available services for different data forwarding policies, according to an embodiment of the present disclosure. As illustrated, the data forwarding policy may be based on mix-zone, partial cryptographic and position ID. Further, different services may require different data forwarding policies according to security requirements, QoS requirements for data packets and network traffic information. The different services or features may include emergency services (e.g., 911 service), high secure services (e.g., military service), reliable services (e.g., uRLLC), normal services (e.g., voice or call), low-resource services (e.g., mMTC), and roaming services (e.g., V2x). For example, data forwarding policies that may satisfy security requirements and QoS requirements for emergency services may include data forwarding policy based on partial cryptographic or data forwarding policy based on position ID due to, for example low delay in these two solutions. For the case of high secure services, data forwarding policy based on partial cryptographic may satisfy the security and QoS requirements because data forwarding policy based on partial cryptographic may allow for high security performance. For low-resource services, data forwarding policy based on mix-zone and data forwarding policy based on position ID may be adequate to meet the security and QoS requirement due to low computation overhead in these two solutions.

As illustrated in FIG. 6, data forwarding based on mix-zone may be meet the requirements for normal services and low-resource services. Data forwarding based on partial cryptographic may meet the requirements for emergency services, high secure services, reliable services, normal services, and roaming services. And data forwarding based on position ID may meet the requirements for emergency services, reliable services, normal services, and low-resource services.

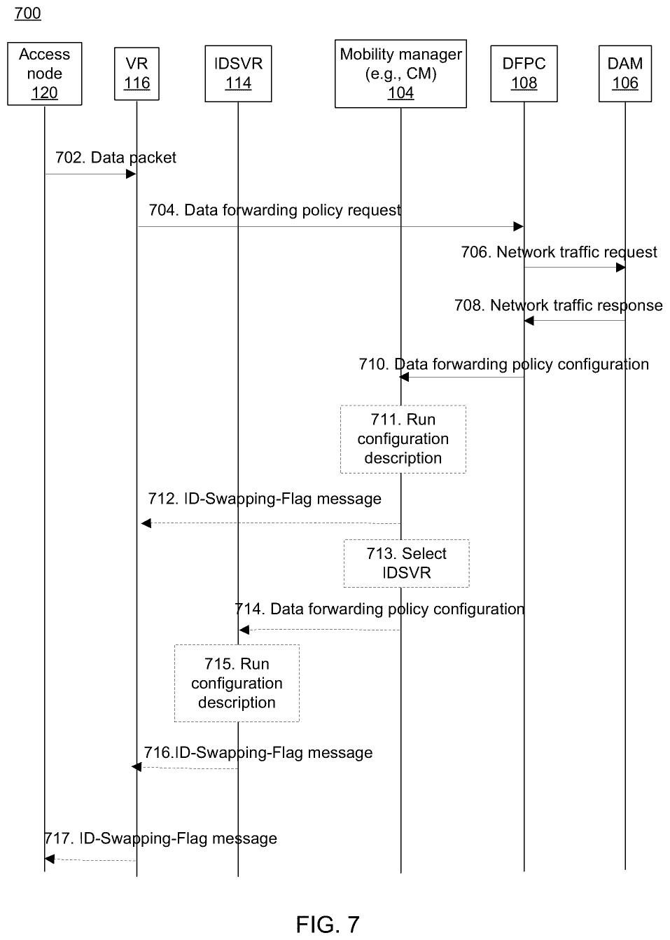

FIG. 7 illustrates a call flow procedure for data forwarding policy configuration, according to an embodiment of the present disclosure. The procedure in FIG. 7 may be similar to the procedure illustrated in FIG. 2.

At 702, an access node 120 may send a data packet to a VR node 116. This data packet may include one or more parameters, e.g., flow ID, source address (e.g., Source-ID), destination address (e.g., DESTI-ID), data forwarding policy requirements. DESTI-ID may be also be referred to as DESTI-account.

At 704, if the VR 116 does not know the destination address (e.g., DESTI-ID) and the value of the Flag does not show that any data forwarding policy is configured in the network, the VR node 116 may send a data forwarding policy request to DFPC 108. The data forwarding policy request may include one or more parameters, e.g., flow ID and data forwarding policy requirements. In some embodiments, the data forwarding policy request may be delivered to DFPC 108 via IDSVR node 114, or mobility manager, 104 or DAM 106, or both IDSVR node 114 and mobility manager 104.

After receiving the data forwarding policy request, DFPC 108 may, at 706, send a network traffic request to DAM 106. The network traffic request may include one or more parameters, e.g., network traffic information (e.g., traffic load in the network, information about traffic load in VR nodes 116 or IDSVR nodes 114).

The DAM 106 may, at 708, send a network traffic response back to DFPC 108. This response may include one or more parameters, e.g., network traffic load in VR nodes 116 or IDSVR nodes 114.

After receiving the network traffic response, DFPC 108 may decide on the data forwarding policy according to network traffic information and the data forwarding policy requirements. Then, DFPC 108 may, at 710, send a data forwarding policy configuration message to mobility manager (e.g., CM) 104. The data forwarding policy configuration message may include one or more parameters, e.g., flow ID, configuration description about the required data forwarding policy, parameters about data forwarding policy (e.g., the value of K used in the data forwarding based on mix-zone, or, one or more of encryption and decryption algorithms, or, an indication of criteria or factors of IDSVR node selection).

In some embodiments, after receiving the data forwarding policy configuration message, mobility manager (e.g., CM) 104 may, at 711, run the configuration description if the required data forwarding policy is a data forwarding based on position ID.

The mobility manager 104 may set the value of Flag according to the data forwarding policy configuration. Then, the mobility manager 104 may, at 712, send the ID-Swapping-Flag message to the VR node 116. The ID-Swapping-Flag message include one or more parameters, e.g., DESTI-ID and value of the Flag.

In other embodiments, if the data forwarding policy is not based on position ID, the mobility manager 104 may select IDSVR node (e.g., IDSVR node 114), and then forward, at 714, the data forwarding policy configuration message to the IDSVR node 114. The IDSVR node 114 may run the configuration description at 715. The IDSVR node 114 may set the value of Flag according to the data forwarding policy configuration and then configure the parameters about data forwarding policy. Then, IDSVR node 114 may, at 716, send the ID-Swapping-Flag message to the VR node 116. This message may include one or more parameters, e.g., flow-ID, value of the Flag.

In some embodiments, wherein the value of Flag means or indicates that data forwarding is based on partial cryptographic, the VR node 116 may, at 717, send the ID-Swapping-Flag message together with IDSVR's public key to the access node 120.

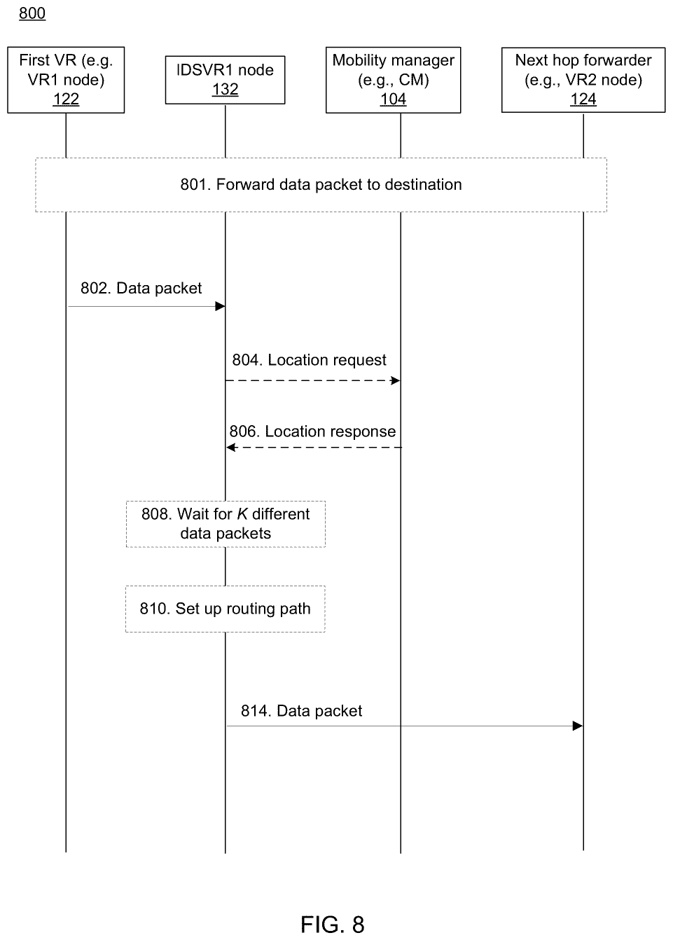

FIG. 8 illustrates a call flow procedure for data forwarding based on mix-zone during data forwarding, according to an embodiment of the present disclosure. The procedure in FIG. 8 may be similar to the procedure illustrated in FIG. 3.

Referring to FIG. 8, at 801, after a VR node (e.g., VR1 122) receives a data packet, VR1 122 may check whether the destination identifier whether is in the network. If the destination identifier is in the network, VR1 122 may search the destination's location if the VR1 node 122 does not know the destination's location. Further details on how the VR1 node 122 may search the location of the destination is described elsewhere herein. VR1 122 may determine the next hop forwarder based on the destination's location. Then, VR1 122 may forward the data packet to the next hop until the data packet arrives at the destination. The data packet may include at least one or more parameters, e.g., flow ID, data forwarding policy requirements, source identifier (e.g., Source-ID), destination identifier (e.g., DESTI-ID) and content of data.

In some embodiments, if the data packet satisfies a set of conditions, then VR node 122 may, at 802, forward the data packet to an IDSVR node (e.g., IDSVR1 node 132). The set of conditions may include that the destination identity is not on the network. The set of conditions may further include that data forwarding based on mix-zone is required. The set of conditions may further include that the value of Flag shows or indicates that data forwarding based on mix-zone is configured. This IDSVR1 node 132 may be selected according to the distance between the IDSVR1 node 132 and VR1 node 122, or traffic load on IDSVR1 node 132, or other selected criteria.

After receiving the data packet, the IDSVR node (e.g., IDSVR1 node 132) may swap the destination identifier (e.g., DESTI-ID) with the serving identifier (e.g., S-ID2) of the destination. If IDSVR1 node 132 does not know the location of the destination, the IDSVR node (e.g., IDSVR1 132) may, at 804, send a location request to the mobility manager (e.g., CM) 104. The location request may include one or more parameters, e.g., the serving identifier of the destination (e.g., S-ID2) and location granularity. The location request may be delivered in a secure communication channel. In some embodiments, if the IDSVR node (e.g., IDSVR1 132) does not swap the destination identifier, the serving identifier of the destination may be replaced by the current identifier (e.g., DESTI-ID) of the destination in the location request message.

At 806, the mobility manager (e.g., CM) 104 may send a location response to the IDSVR node (e.g., IDSVR1 node 132). This location response may include S-ID2 and the destination's location.

After receiving the location response from mobility manager 104, the IDSVR node (e.g., IDSVR1 node 132) may, at 808, perform one or more functions. The IDSVR1 node 132 may wait for at least k data packets having different destinations if the at least k data packets do not have requirements of real-time or emergency. The IDSVR1 node 132 may further map the destination identifier (e.g., DESTI-ID) to the serving identifier (e.g., ID2) of the destination. The IDSVR1 node 132 may further determine the next hop forwarder based on the location of the destination using existing routing protocols, e.g., distance-vector routing protocol which measures the distance by the number of routers a packet has to pass.

At 810, the IDSVR node (e.g., IDSVR1 node 132) may forward the at least k data packets, with a different sequence than the sequence in which the at least k data packets entered the IDSVR (e.g., IDSVR1 node 132), to the next hop forwarder until the at least k data packets arrive at their destinations. For example, if k=4, data packet 1 may arrive at the IDSVR1 node 132 at time t1, data packet 2 may arrive at the IDSVR1 node 132 at time t2, data packet 3 may arrive at the IDSVR1 node 132 at time t3, data packet 4 may arrive at the IDSVR1 node 132 at time t4, such that t4>t3>t2>t1. Then the departure sequence for the data packets may be random and different from the sequence they arrived at the ISDVR1 node 132, for example the sequence of data packets leaving the ISDVR node 132 may be data packet 4, data packet 1, data packet 3, and data packet 2.

Accordingly, at 814, IDSVR1 node 132 may send the data packet to the next hop node, e.g., VR2 node 124. This data packet may include one or more parameters, e.g., flow ID, Source-ID, and serving identifier (e.g., S-ID2) of the destination.

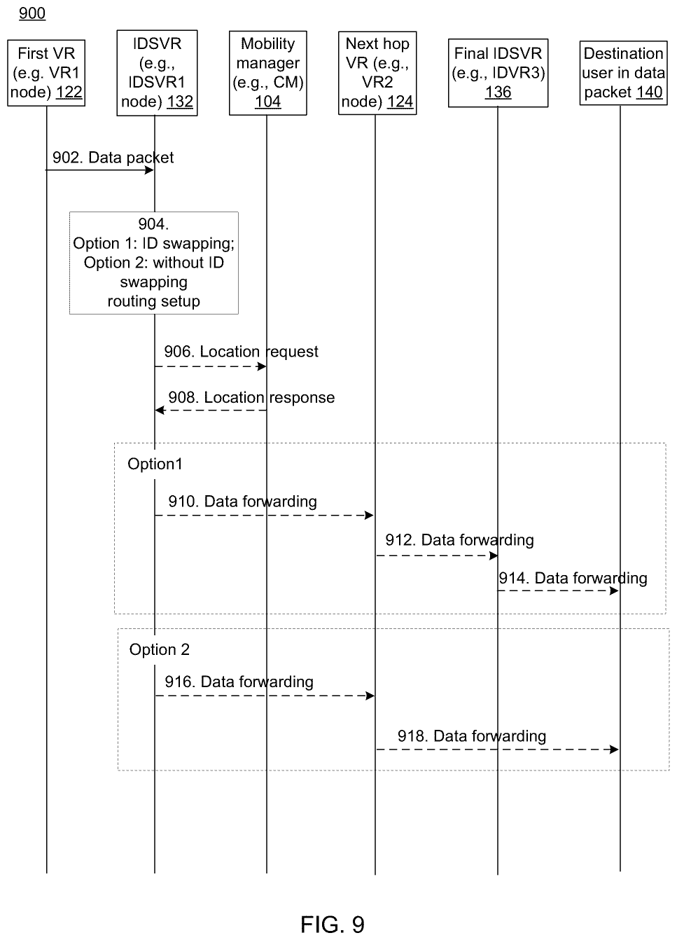

FIG. 9 illustrates a call flow procedure for data forwarding based on partial cryptographic during data forwarding, according to an embodiment of the present disclosure. The call flow procedure in FIG. 9 may be similar to the procedure illustrated in FIG. 4.

At 902, when a data packet arrives at the first VR node (e.g., VR1 122), VR1 node 122 may forward the data packet to an assigned IDSVR node (e.g., IDSVR1 132). The data packet may include one or more parameters, e.g., flow ID, data forwarding policy requirements, source identifier (e.g., Source-ID), destination identifier (e.g., DESTI-ID), content of data, and IDSVR node identifier (e.g., IDSVR1). The destination identifier, DESTI-ID, may be encrypted using an IDSVR node's (e.g., IDSVR1 node 132) public key. Note that IDSVR node 132 may be a node that is the closest to the first VR node (e.g., VR1 node 122).

After receiving the data packet, the IDSVR node (e.g., IDSVR1 node 132) may, at 904, have two options. The first option may apply where the destination identity (e.g., DESTI-ID) is unknown to the network. In first option, the IDSVR node (e.g., IDSVR1 node 132) may swap the destination identifier with the serving identifier of the destination according to the IDVSR node's 132 temporary ID mapping table (which may be pre-configured to IDSVR1 node 132). For example, DESTI-ID may be mapped with serving identifier S-ID2. The second option may apply where the destination identity (e.g., DESTI-ID) is known by the network.

After receiving the data packet, if the IDSVR node (e.g., IDSVR1 132) does not know the location of the destination, it may, at 906, send a location request to the mobility manager (e.g., CM) 104. The location request may include one or more parameters, e.g., destination identifier (e.g., DESTI-ID) or serving identifier of the destination (e.g., S-ID2), and location granularity. Note that the location request may be delivered in a secure communication channel for ensuring security protection for destination identifier.

The mobility manager (e.g., CM) 104 may, at 908, send a location response to the IDSVR node (e.g., IDSVR1 node 132). This location response may include the destination's location.

In embodiments in which the first option applies, e.g., where the destination identity (e.g., DESTI-ID) is unknown to the network, the procedure may follow 910, 912 and 914 as illustrated. The IDSVR node (e.g., IDSVR1 132) may establish a routing table and, at 910, forward the data packet to the next hop VR (e.g., VR2) based on the destination's location. Note that the IDSVR node 132 may use existing routing protocols to establish the next hop forwarder, e.g., distance-vector routing protocol which measures the distance by the number of routers a packet has to pass. The data packet may include one or more parameters, e.g., flow ID, Source-ID, the serving identifier “S-ID2” of the destination which is encrypted using an available IDSVR (e.g., IDSVR3 node 136) node's public key, and identifier of the IDSVR. The available IDSVR node may be determined according to the destination's location, e.g., the IDSVR node that is closest to the destination's location may be selected.

When the serving VR node (e.g., VR2 node 124) where the destination node is located, receives the data packet according to the first option, the serving VR node may, at 912, send the data packet to the IDSVR node (e.g., IDSVR3 node 136).

After receiving the data packet based on the first option, the IDSVR node (e.g., IDSVR3 node 136) may decrypt and obtain the destination identifier (“S-ID2”). The IDSVR node (e.g., IDSVR3 node 136) may, at 914 send the data packet to the destination node or user 140. If the destination node is not in the coverage of the IDSVR3 node 136, the data packet may be passed through one or more VR nodes. The data packet may include one or more parameters, e.g., flow ID, Source-ID, and the serving identifier ID2 of the destination (S-ID2).

In embodiments in which the second option applies, e.g., the destination identity (e.g., DESTI-ID) is known by the network, then the procedure may follow 916 and 918, as illustrated.

According to the second option, at 916, IDSVR node (e.g., IDSVR1 node 132) may establish a routing table and forward the data packet to the next hop VR (e.g., VR2 node 124) based on the destination's location. The IDSVR1 node 132 may use existing routing protocols to establish the next hop forwarder, e.g., distance-vector routing protocol which measures the distance by the number of routers a packet has to pass. The data packet may include one or more parameters, e.g., flow ID, source identifier, destination identifier (e.g., DESTI-ID).

According to the second option, at 918, when the serving VR node (e.g., VR2 node 124), where the destination node is located, receives the data packet, the serving VR node may send the data packet to the destination user 140 directly.

Embodiments described in FIGS. 7, 8 and 9 may provide for call flows or flow charts for procedures illustrated in FIGS. 2, 3 and 4 respectively.

Embodiments described herein may provide for an architecture including one or more functions, e.g., IDSVR nodes 114 and DFPC 109. The architecture described herein may provide protection for ID privacy during data forwarding. The architecture may further provide for customized data forwarding policy based on different services to protect ID privacy during data forwarding.

Embodiments described herein may provide for data forwarding policy configuration. Embodiments may further provide for a DFPC 108 functionality which may provide for a dynamic data forwarding policy based on traffic load and data requirements. The data forwarding policies may protect ID privacy during data forwarding and provide for swapping ID in the UP layer or the CP layer.

Embodiments described herein may provide for data forwarding based on position ID. Embodiments described herein may provide for data forwarding based on mix-zone, including enhanced features or functionalities in IDSVR nodes 114. Embodiments described herein may provide for data forwarding based on partial cryptographic, including enhanced features or functionalities in IDSVR nodes 114.

It should be appreciated that while embodiments describe certain method steps performed by specific network functions above, in other embodiments, some of the functionality can be performed by other functions. For example, while embodiments have been discussed with respect to management function 104 performing steps of determining and sending the indication and the corresponding flag based on the received policy, it should be appreciated that in other embodiments, the IDSVR 114 can perform some of all of these steps.

A person skilled in the art may appreciate that embodiments described herein may be used in Internet of Things (IoT) and Interne of vehicles (IoV) scenarios. Further, embodiments described herein may be applied to applications such as satellite communication and IoV. In these scenarios or applications, the destination identifier in the data packet may be referred to a identifier of UE, or identifier of terminal device (e.g., IoT devices, wearable devices, and vehicular devices (or vehicle-mounted devices, vehicle on-board equipment)).

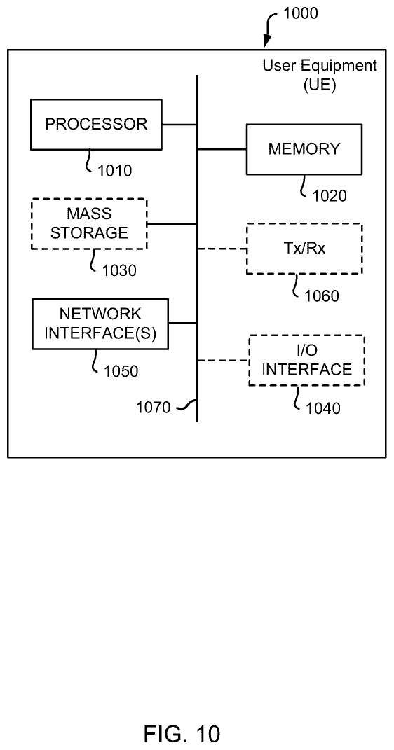

FIG. 10 is a schematic diagram of UE 1000 that may perform any or all of operations of the above methods and features explicitly or implicitly described herein, according to different embodiments of the present invention. For example, a computer equipped with network function may be configured as UE 1000. As may be appreciated by a person skilled in the art, UE 1000 may refer to a terminal device, a mobile device, an M2M device, or an IoT device.

As shown, the UE 1000 may include a processor 1010, such as a Central Processing Unit (CPU) or specialized processors such as a Graphics Processing Unit (GPU) or other such processor unit, memory 1020, non-transitory mass storage 1030, input-output interface 1040, network interface 1050, and a transceiver 1060, all of which are communicatively coupled via bi-directional bus 1070. According to certain embodiments, any or all of the depicted elements may be utilized, or only a subset of the elements. Further, UE 1000 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 1020 may include any type of non-transitory memory such as static random access memory (SRAM), dynamic random access memory (DRAM), synchronous DRAM (SDRAM), read-only memory (ROM), any combination of such, or the like. The mass storage element 1030 may include any type of non-transitory storage device, such as a solid state drive, hard disk drive, a magnetic disk drive, an optical disk drive, USB drive, or any computer program product configured to store data and machine executable program code. According to certain embodiments, the memory 1020 or mass storage 1030 may have recorded thereon statements and instructions executable by the processor 1010 for performing any of the aforementioned method operations described above.

Embodiments of the present invention can be implemented using electronics hardware, software, or a combination thereof. In some embodiments, the invention is implemented by one or multiple computer processors executing program instructions stored in memory. In some embodiments, the invention is implemented partially or fully in hardware, for example using one or more field programmable gate arrays (FPGAs) or application specific integrated circuits (ASICs) to rapidly perform processing operations.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

1. A method comprising:
receiving, by a management function from a policy controller, a first message including a data forwarding policy indicative of a configuration on how to forward data according to a data forwarding requirement from an original data sender;
sending, by the management function to a network function, a second message according to the first message; and
obtaining, by the network function, an indication indicating a request for data forwarding and a corresponding flag indicating an ID swapping rule according to the second message.

2. The method of claim 1 further comprising:
determining, by the management function, the second message according to the first message, wherein the second message includes the indication and the corresponding flag.

3. The method of claim 2 wherein the management function is trusted by the original data sender, the method further comprises:
determining, by the management function, an ID swapping rule comprising a policy of forwarding data based on a position ID of a destination of the data packet from the original data sender;
wherein according to the ID swapping rule:
the data packet is forwarded to the destination according to the position ID via the network function and other network functions between the original data sender and the destination, and an ID of the destination of the data packet in the data packet is swapped by the management function with a serving ID of the destination of the data packet which is recognizable by a network including the network function.

4. The method of claim 2, wherein the position ID is assigned by the management function to the destination of the data packet.

5. The method of claim 4, wherein the position ID of the destination is assigned based on an ID of another network function associated with the destination.

6. The method of claim 1 wherein the second message includes a third message from management function to a second network function and a fourth message from the second network function to the network function.

7. The method of claim 6 further comprising:
selecting, by the management function, the second network function from a set of second network functions according to the first message;
sending the third message to the second network function, wherein the third message includes the data forwarding policy;
determining, by the second network function, the indication and the corresponding flag according to the data forwarding policy, and
sending, by the second network function to the network function, the indication and the corresponding flag.

8. The method of claim 6, wherein the second network function is trusted by the original data sender, wherein the method further comprises:
determining, by the second network function, an ID swapping rule comprising a policy of forwarding data based on a policy of forwarding data based on partial cryptographic;
wherein according to the ID swapping rule:
the destination ID of a data packet or a serving ID corresponding to the destination ID is encrypted by the second network function according to a public key of another network function trusted by the original data sender and associated with a destination of the data packet, and an ID of the destination of the data packet in the data packet is swapped by the management function with a serving ID of the destination of the data packet which is recognizable by a network including the another network function.

9. The method of claim 6 further comprising:
sending, by the network function to an access network (AN) node, a public key associated with the second network function for encrypting a destination ID of a data packet.

10. The method of claim 6 wherein the second network function is trusted by the original data sender, wherein the method further comprises:
determining, by the second network function, an ID swapping rule comprising a policy of forwarding data based on a policy of forwarding data based on a mix-zone;
wherein according to the ID swapping rule:
more than a certain amount of data packets targeting different destinations are to be forwarded by the second network function in a sequence different from what sequence they are received by the second network function, and an ID of the destination of the data packet in the data packet is to be swapped by the management function with a serving ID of the destination of the data packet which is recognizable for the network including the network function.

11. The method of claim 8 wherein the method further comprises:
determining, by the second network function, the serving ID according to a mapping between destination IDs and serving IDs.

12. The method of claim 1 further comprising:
sending, by the network function to the policy controller, a policy request to trigger the policy controller to generate the data forwarding policy, wherein the policy request includes the data forwarding requirement.

13. The method of claim 12 further comprising:
obtaining, by the network function from an access network node associated with the original data sender, the data forwarding requirement.

14. The method of claim 13, wherein the data forwarding requirement is included in a data packet from the original data sender.

15. The method of claim 1 further comprising:
generating, by the policy controller, the data forwarding policy after receiving the policy request; and
sending, by the policy controller to the management function, the second message including the data forwarding policy.

16. (canceled)

17. (canceled)

18. (canceled)

19. A communication system comprising:
at least one processor; and
non-transient memory storing machine readable instructions which when executed by the least one processor implement a management function, a policy controller and a network function, said management function, policy controller and network function configured for:
receiving, by the management function from the policy controller, a first message including a data forwarding policy indicative of a configuration on how to forward data according to a data forwarding requirement from an original data sender;
sending, by the management function to the network function, a second message according to the first message;
obtaining, by the network function, an indication indicating a request for data forwarding and a corresponding flag indicating an ID swapping rule according to the second message.

20. (canceled)

21. A method comprising:
receiving, by a network function, a message including a data forwarding policy, the data forwarding policy indicative of a configuration on how to forward data according to a data forwarding requirement from an original data sender;
determining, by the network function, an indication indicating a request for data forwarding and a corresponding flag indicating an ID swapping rule according to the data forwarding policy; and
sending, by the network function to another network function, the indication and the corresponding flag;
wherein the network function is trusted by the original data sender.

22. The method of claim 21 wherein the method further comprises:
determining, by the network function, an ID swapping rule comprising a policy of forwarding data based on a position ID of a destination of the data packet from the original data sender;
wherein according to the ID swapping rule:
the data packet is forwarded to the destination according to the position ID via one or more other network functions between the original data sender and the destination, and an ID of the destination of the data packet in the data packet is swapped by the network function with a serving ID of the destination of the data packet which is recognizable by a network including the another network function which receives the indication and the corresponding flag.

23. (canceled)

24. (canceled)

25. (canceled)

26. (canceled)

27. (canceled)

28. (canceled)

29. A method comprising:
receiving, by a policy controller, a policy request to trigger the policy controller to generate a data forwarding policy, the policy request including a data forwarding requirement from an original data sender;
generating, by the policy controller, the data forwarding policy after receiving the policy request; and
sending, by the policy controller, a first message to a management function, the first message including the data forwarding policy indicative of a configuration on how to forward data according to the data forwarding requirement.

30. The method of claim 29 wherein the data forwarding policy indicative of a configuration on how to forward data further depends on network traffic information, wherein the network traffic information includes at least one traffic parameter associated with one or more of the network function and another network function associated with the network function.

31. (canceled)

32. (canceled)

33. (canceled)

34. (canceled)

35. (canceled)

36. (canceled)
